(19) United States
(12) Patent Application Publication
(10) Pub. No.: US 2014/0284844 A1
(43) Pub. Date: Sep. 25, 2014

(54) Precast Pervious Concrete Panels

(71) Applicant: THE SPANCRETE GROUP, INC., Waukesha, WI (US)

(72) Inventors: Daniel J. WILLEMS, Hartland, WI (US); John NAGY, Chenequa, WI (US); Alan ANTONIEWICZ, Pewaukee, WI (US); Paul STAROSZCZYK, Elkhorn, WI (US)

(73) Assignee: THE SPANCRETE GROUP, INC., Waukesha, WI (US)

(21) Appl. No.: 14/296,776

(22) Filed: Jun. 5, 2014

Related U.S. Application Data
(62) Division of application No. 13/915,954, filed on Jun. 12, 2013.
(60) Provisional application No. 61/658,625, filed on Jun. 12, 2012.
(60) Provisional application No. 61/659,726, filed on Jun. 14, 2012.
(60) Provisional application No. 61/761,564, filed on Feb. 6, 2013.

(51) Int. Cl. B29D 99/00; E04C 2/04

(52) U.S. Cl. CPC B29D 99/001; E04C 2/04
USPC 264/275

(57) ABSTRACT

A precast pervious concrete panel is formed in a containment vessel under controlled conditions and allowed to reach an acceptable strength before removal from the containment vessel, thereby producing standard sizes or shapes for installation in the field. Each piece of pervious concrete may include slots cut into the piece at predetermined locations allowing installation of a joint connector; either dry or with a bonding material thereby allowing connection of multiple pieces into a solid slab. A strip material may be used under the slab joints to dissipate load bearing and allow the panels to slide together when picked up by the embedded lifting device. Multiple pervious concrete pieces can be combined with a collection system allowing collection/reuse of water passing through the panels. Precast pervious concrete panels can be used as inserts in ready mix or cast in place concrete frames allowing for easy replacement of the pieces.

### RELATED APPLICATIONS

This application is a divisional of pending U.S. patent application Ser. No. 13/915,954, filed 12 Jun. 2013, which claims the benefit of U.S. Provisional Patent Application Ser. No. 61/658,625, filed 12 Jun. 2012; U.S. Provisional Patent Application Ser. No. 61/659,726, filed 14 Jun. 2012; and U.S. Provisional Patent Application Ser. No. 61/761,564, filed 6 Feb. 2013, all entitled Precast Pervious Concrete Panels.

### BACKGROUND OF THE INVENTION

Pervious concrete is a type of concrete that is highly porous to allow water, for example from precipitation, to pass through the concrete. The use of pervious concrete will reduce runoff from a site. As such, the use of pervious concrete is consistent with ecologically sustainable construction practices. Pervious concrete may be used for parking lots, sidewalks, driveways, and roadways, as a few non-limiting examples.

The porous nature of pervious concrete is achieved by the materials that are put into the concrete. Specifically, pervious concrete is a mix of course aggregate, cement, water, chemicals or “add material,” and little to no sand. This mixture creates an open-cell structure in the concrete, which allows water to filter though the pervious concrete.

Pervious concrete is typically used in a “ready mix” fashion, delivered to a jobsite and poured into an on-site form. Pervious concrete is unique in many ways including the long cure time to reach maximum strength; due to the makeup of pervious concrete, the cure time required to reach full strength is typically 28 days or longer. The pervious concrete material must be covered and controlled during the cure time. During thus cure time the product does not provide maximum protection and is prone to dilution from water, cracking from stressing or reduced ultimate strength due to temperature.

### SUMMARY OF THE INVENTION

The present invention relates to pervious concrete, and more particularly to precast pervious concrete panels. The panels comprise elements such as at least one lifting member or pocket to promote easier lifting for transporting the panel and at least one aperture for insertion of a connector used to join panels together.

Furthermore, the present invention may be used in association with non-pervious surfacing material as part of a drainage system.

It is further contemplated by the present invention that various ratios of sand and various aggregate sizes may be used for applications requiring different strength characteristics.

One aspect of the invention provides a preformed pervious concrete panel including a concrete mix having an aggregate size in the range of about one-eighth inch to about three-quarters inch and a sand content ratio in the range of zero percent to ten percent, a peripheral surface, a least one lifting member at least partially integrated into the peripheral surface, and at least one aperture located in the peripheral surface.

The aggregate size may also be in the range of about one-eighth inch to about one-half inch.

The sand content ratio may also be in the range of 1 percent to 7 percent.

The sand content ratio may also be zero percent.

The pervious concrete panel may also include a void ratio in the range of 16 percent to 22 percent.

The void ratio may also be in the range of 18 percent to 22 percent.

The at least one ting member may also be a female connector.

The at least one lifting member may also be a steel cable loop.

The at least one aperture may extend continuously linearly through the panel.

Another aspect of the invention provides a pervious concrete system including at least a first and a second preformed pervious concrete panels, each of the preformed pervious concrete panels including a concrete mix having an aggregate size in the range of about one-eighth inch to about three-quarters inch and a sand content ratio in the range of zero percent to ten percent, a peripheral surface, at least one lifting member at least partially integrated into the peripheral surface, and at least one aperture located in the peripheral surface; at least one connector having a first and a second oppositely disposed ends; and wherein the first end of the connector is received in an aperture of a first panel and the second end of the connector is received in an aperture of the second panel, thereby joining the first and second panels.

The pervious concrete system may also include a piece of strip material placed underneath the panels at the joint.

The at least one connector may have a hard-stop to provide a gap between the panels.

Another aspect of the invention provides a method for producing a pervious concrete panel including providing a pervious concrete mix having a an aggregate size in the range of about one-eighth inch to about three-quarters inch and a sand content ratio in the range of zero percent to ten percent, providing a containment vessel having a shape defining the peripheral surface of the panel, providing at least one lifting member, introducing the pervious concrete mix into the containment vessel, forming at least one aperture in the peripheral surface, arranging the lifting member in the mix at a predetermined location in the peripheral surface prior to the mix fully curing, allowing the pervious concrete mix to cure for a predetermined amount of time, and separating the panel from the containment vessel.

The aggregate size may also be in the range of about one-eighth inch to about one-half inch.

The sand content ratio may also be in the range of 1 percent to 7 percent.

The sand content ratio may also be zero percent.

The method for producing a pervious concrete panel may also include a pervious concrete panel with a void ratio in the range of 16 percent to 22 percent.

The void ratio may also be in the range of 18 percent to 22 percent.

Another aspect of the invention provides a method for producing a pervious concrete panel including providing a pervious concrete mix having a an aggregate size in the range of about one-eighth inch to about three-quarters inch and a sand content ratio in the range of zero percent to 10 percent, providing at least one lifting member, forming the panel having a peripheral surface with a continuously moving form, forming at least one aperture in the peripheral surface, arranging the lifting member in the mix at a predetermined location in the peripheral surface prior to the mix fully curing.

The method for producing a pervious concrete panel may include forming the panel with a slip-forming machine.

The method for producing a pervious concrete panel may include forming the panel with an extruding machine.

The aggregate size may also be in the range of about one-eight inch to about one-half inch.

The sand content ratio may also be in the range of 1 percent to 7 percent.

The sand content ratio may also be zero percent.

The method for producing a pervious concrete panel may also include a pervious concrete panel with a void ratio in the range of 16 percent to 22 percent.

The void ratio may also be in the range of 18 percent to 22 percent.

### BRIEF DESCRIPTION OF THE DRAWINGS

FIG. 1 is a perspective view of a precast pervious concrete panel being formed in a containment vessel.

FIG. 2 is a perspective view of a precast pervious concrete panel according to the present invention.

FIG. 3 is a perspective view of two precast pervious concrete panels of FIG. 2 being joined in according to the present invention.

FIG. 4 is a perspective view of an insert which may be used with the present invention.

FIG. 5 is a perspective view of the insert of FIG. 4 incorporated in a precast pervious concrete panel according to the present invention.

FIG. 6 is a side view of a water collection system incorporating three of the precast pervious concrete panels of FIG. 2.

FIG. 7 is a top plan view of a concrete system incorporating conventional concrete and one or more of the precast pervious concrete panels of FIG. 2.

FIG. 8 is a cross sectional view of a portion of the system of FIG. 7.

FIG. 9 is a side perspective view of a precast pervious concrete panel having a hollow core according to the present invention.

FIG. 10 is an exploded perspective view of a system incorporating two of the precast pervious concrete panel of the present invention and a connector member connecting the panels.

FIG. 11 is an alternative arrangement of a hollow core according to the present invention.

FIG. 12 is an alternative connector member for connecting the panels.

FIG. 13 is an exploded perspective view of a system incorporating two of the precast pervious concrete panel of the present invention and the connector of FIG. 12 connecting the panels.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

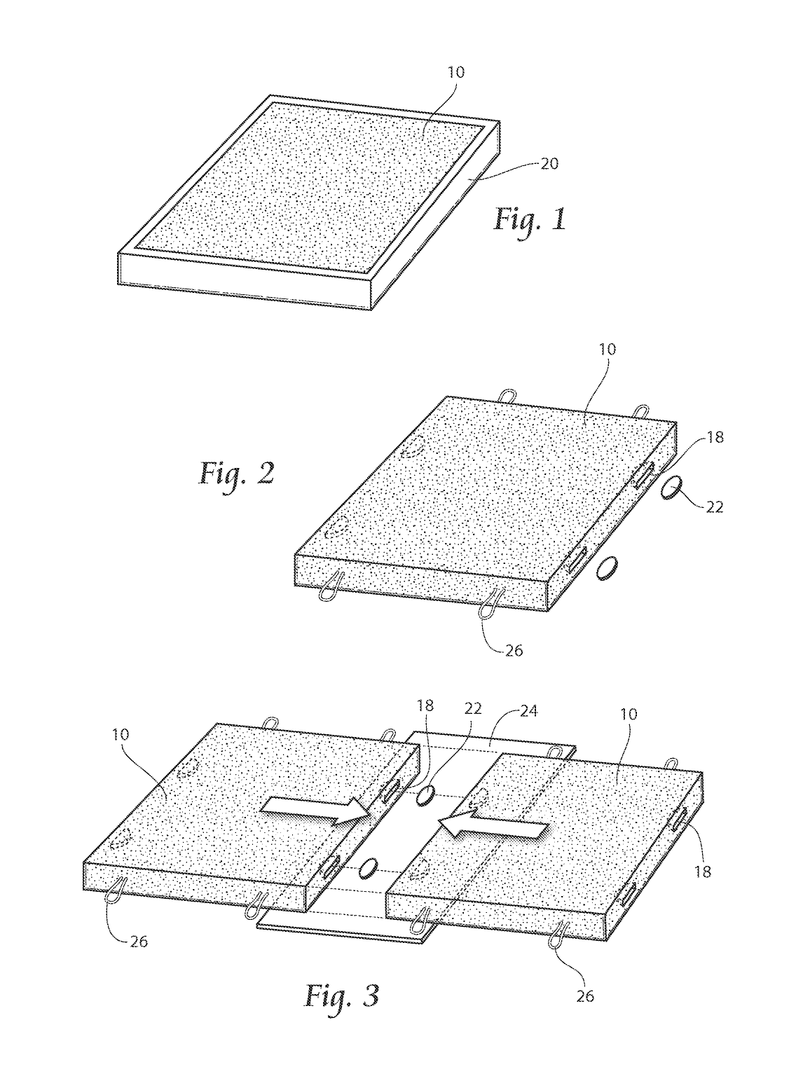

FIG. 1 shows a precast pervious concrete panel 10 being formed in a containment vessel 20. In this manner, the precast pervious concrete panel 10 can be formed and cured in a controlled environment in lieu of pouring wet cast concrete at a jobsite with uncontrolled environment. It should be understood that while a square containment vessel 20 is shown, the containment vessel 20 and thus the panel 10 may be formed in any shape desired, including, but not limited to, square, rectangular, circular, or elliptical forms. In this manner, the invention allows the pervious concrete to be made into standard sizes or shapes and produced in a controlled environment thereby ensuring better quality, strength and consistency.

The precast pervious concrete panels 10 are preferably sized and configured to be connected to one another. The precast pervious concrete panels 10 may be connected using any methods known in the art. One such method is shown in FIGS. 2 and 3. FIG. 2 shows an embodiment of a precast pervious concrete panel 10 according to the present invention. The precast pervious concrete panel 10 preferably includes one or more slots 18 cut into the panel 10 at predetermined locations along one or more sides of the panel 10. The slots 18 are preferably sized and configured to accept a connecting member 22. FIG. 3 shows a pair of precast previous concrete panels 10 being connected to one another. As shown in FIG. 3, it should be understood that two adjacent precast pervious concrete panels 10 should each have corresponding slots 18 to accept a connecting member 22. The number of slots 18 and connecting members 22 may be as few or as numerous as desired.

The connecting member 22 may take any form known in the art and may be made of any material known in the art. In the illustrated embodiment of FIG. 3, the connecting member 22 has a generally oval shape and is made of Korlath. The joint between the precast pervious concrete panels 10 may be dry fitted or a bonding material, such as epoxy, may be used to secure the adjacent precast pervious concrete panels 10. If used, the bonding material may be used along the entire joint or only at the locations of the slots 18 and connecting members 22.

A panel of strip material 24 may be provided under one or more joints between adjacent precast pervious concrete panels 10. The use of the strip material 24 under the joints will reduce stress concentration at the joint connection by dissipating the load bearing, ensure debris is not pinched between panels 10, and allow the panels 10 to slide easily together. If used, the strip material 24 may take any form known in the art and may be made of any material known in the art. In the illustrated embodiment the strip material 24 is generally rectangular and is made of Korlath.

As shown in FIG. 2, each precast pervious concrete panels 10 may also include one or more lifting members 26. In the embodiment shown in FIG. 2 the lifting members 26 take the form of steel cable loops. However, the lifting members 26 may take any form known in the art, and may be attached to the precast pervious concrete panel 10 using any means known in the art.

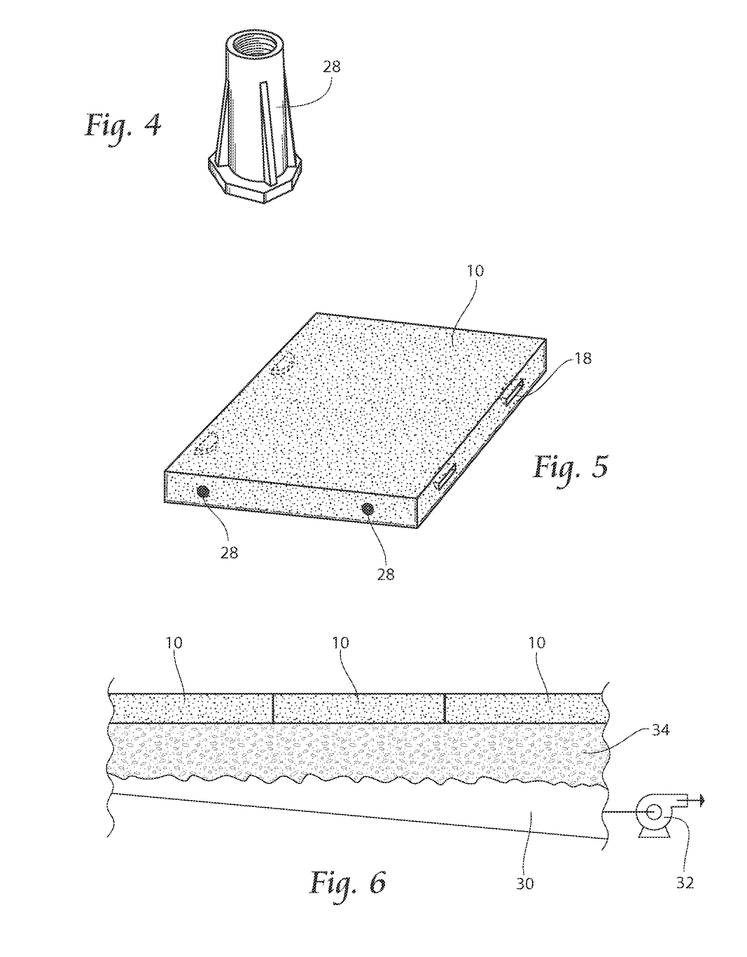

For example, as shown in FIGS. 4 and 5, it is contemplated that the lifting members 26 may take the form of one or more receptacles embedded in the precast pervious concrete panel 10. The receptacle may take any form known in the art including, but not limited to a female connector 28 sized and configured to have a male member (not shown) threaded into the female connector 28. The male member may take any form known in the art and may be used to lift the precast pervious concrete panel 10. Although any number of such lifting members may be utilized, it is contemplated that in one embodiment four female connectors 28 would be embedded in each precast pervious concrete panel 10. The precast pervious concrete panel 10 could then be lifted by a male member threaded into the female connector 28.

As shown in FIG. 6, one or multiple precast pervious concrete panels 10 can be combined in a collection system allowing collection/reuse of water passing through the precast pervious concrete panels 10. In such a system a means of collecting water, such as a cistern 30, is placed beneath the precast pervious concrete panels 10. The cistern 30 may be placed directly underneath the panels 10 or may be separated from the panels 10 by a drainage material 34 such as gravel as shown in FIG. 6. As shown in FIG. 6, if desired, the collection system may include a pump 32 to take water from the cistern 30 to distribute the collected water to a desired location.

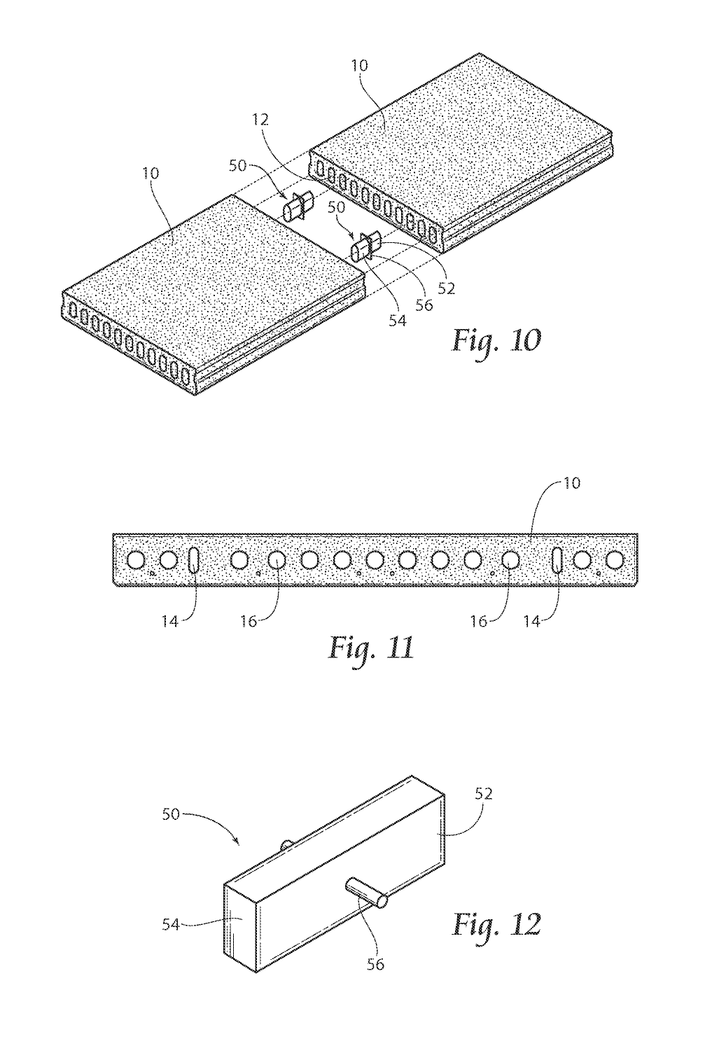

It is further contemplated that the precast pervious concrete panels 10 may be formed using any means known in the art. For example, and not by way of limitation, the precast pervious concrete panels could be formed on a slip-forming or extruder machine. This would produce a precast pervious concrete panel 10 with multiple hollow channels running through the panel 10 as shown in FIG. 9. This would reduce weight of the panels and material consumption by approximately 20-40%.

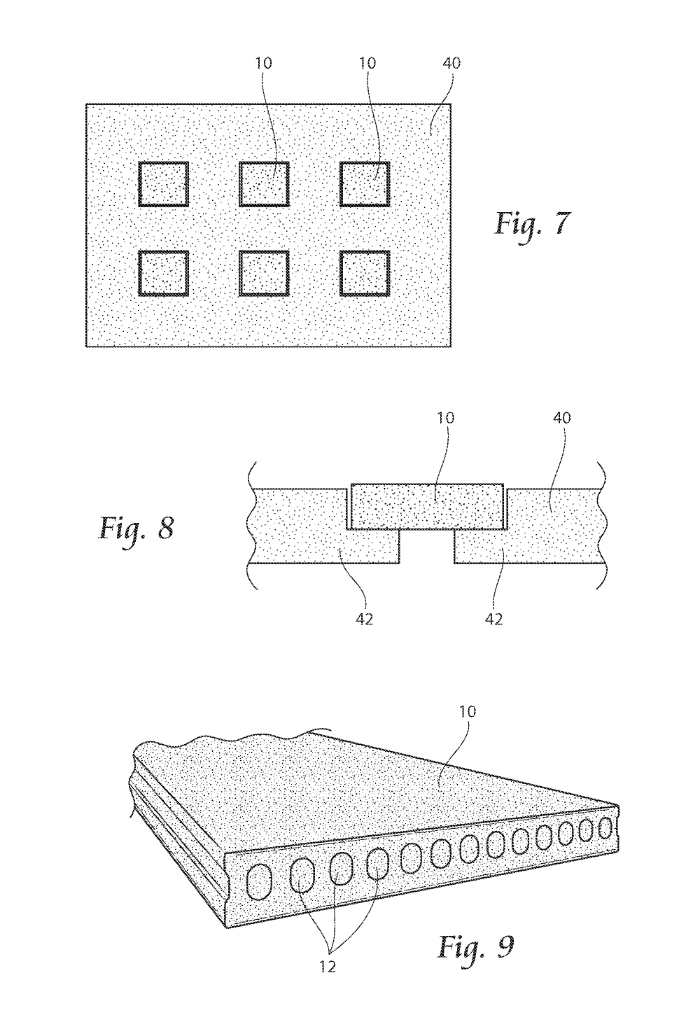

It is further contemplated that precast pervious concrete panels 10 may be used as inserts to be used in combination with traditional concrete or asphalt as shown in FIG. 7. In this manner, conventional concrete 40 could be cast in place, leaving space to insert the precast pervious concrete panels 10. Preferably, conventional concrete 40 would be cast with a ledge 42 so that the precast pervious concrete inserts 10 could sit on the ledge 42 as shown in FIG. 8. This would reduce costs as compared to using pervious concrete alone, and would increase drainage as opposed to using only conventional concrete. The precast pervious concrete panels 10 could be placed in a decorative pattern or arrangement if desired. To that end, if desired, the precast pervious concrete panels 10 could be integrally colored.

It is further contemplated that the precast pervious concrete panels 10 could be reinforced using any means known in the art including, but not limited to, embedding rebar, fibers or mesh in the precast pervious concrete panels 10.

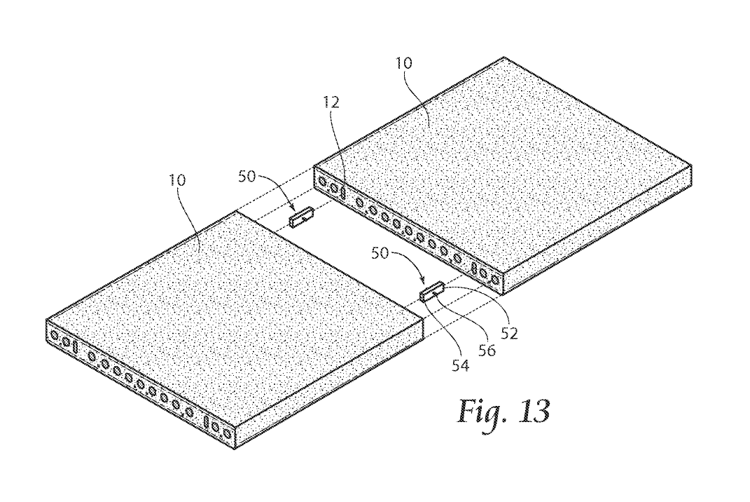

It is further contemplated that the precast pervious concrete panels 10 may be connected in a manner as shown in FIG. 10, with further reference to FIG. 13 illustrating various aperture and connector shapes. It is contemplated that a first precast pervious concrete panel 10 having at least one first aperture 12 could be connected to a second precast pervious concrete panel 10 having at least one second aperture (hidden). The first and second apertures may be formed in the first and second panel using any means known in the art. For example, and not by way of limitation, the first and/or second apertures could be a hollow core extending through the first and/or second panels respectively. It is further contemplated that the first and/or second apertures could be formed in the first and/or second panels. It is contemplated that a connector 50 having a first end 52 sized and configured to fit within and engage the first aperture 12 and a second end 54 sized and configured to fit within and engage the second aperture (hidden) may be utilized to connect the First and second panels 10. It is further contemplated that the connector may include a hard stop 56 such that the first end 52 of the connector 50 will slide into the core of the first panel 10 until it reaches the hard stop 56, the second end 54 of the connector 50 will slide into the core of the second panel 10 until it reaches the hard stop 56. The hard stop 56 will preferably create a gap between the first and second panels. Furthermore, the size of the panel will determine the number of connectors 50, where there could be as few as one or as many as there are apertures in each panel. Additionally, a panel may incorporate apertures of a variety of different shapes or combinations of different shapes. As a non-limiting example, FIG. 11 further illustrates a panel 10 having oval apertures 14 along with circular apertures 16.

The profile of the connectors 50 may substantially match the cores of the panes 10; they may be round or any other shape used to make the panel's core. For example, the connector 50 in FIG. 10 has a “teardrop” shape and the connector 50 in FIGS. 12 and 13 has a rectangular shape. The connectors 50 can be hollow or solid and are preferably made of a non-corrosive material, including but not limited to plastic or metal.

As outlined above, pervious concrete is a mix of course aggregate, cement, water, and little to no sand. It is further contemplated that the precast pervious concrete panels 10 may be cast using any combination of such materials known in the art. However, it is contemplated that the pervious concrete mixture may be designed to meet the specified strength and permeability of the intended application. Typically, the stronger the precast pervious concrete panel 10, the more material required which reduces the permeability, therefore each application may have a unique mix. The mixes will be classified based off their aggregate size and their sand content. Preferably the pervious concrete material will have a range of aggregates typically varying from about ⅛-¾″ in size and sand content ratios up to 10%. For example, a mix for a sidewalk or patio according to the present invention may utilize an aggregate size of about ⅛″-⅜″ and include up to approximately 7% sand content. This mixture would provide a minimum strength of 3,500 psi, an 18-22% void ratio, and infiltration rates exceeding 500 inches/hour. Alternatively, a mix for a highway shoulder or parking stall may employ an aggregate size of about 5/16″-½″ and up to approximately 7% sand content. This mixture would provide a minimum strength of 4,000 psi, a 16-20% void ratio, and infiltration rates exceeding 500 inches/hour.

A method for producing a pervious concrete panel 10 comprises: providing a pervious concrete mix having a predetermined aggregate size and percentage of sand; providing a means for forming the pervious concrete panel; providing a means for lifting the pervious concrete panel; introducing the pervious concrete mix into the forming means; incorporating the lifting means; and curing the pervious concrete mix.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I/we claim:

1. A method for producing a pervious concrete panel comprising:
providing a pervious concrete mix having a an aggregate size in the range of about one-eighth inch to about three-quarters inch and a sand content ratio in the range of zero percent to ten percent;
providing a containment vessel having a shape defining the peripheral surface of the panel;
providing at least one lifting member;
introducing the pervious concrete mix into the containment vessel;
forming at least one aperture in the peripheral surface;
arranging the lifting member in the mix at a predetermined location in the peripheral surface prior to the mix fully curing;
allowing the pervious concrete mix to cure for a predetermined amount of time; and
separating the panel from the containment vessel.

2. The method of claim 1 wherein the aggregate size is in the range of about one-eighth inch to about one-half inch.

3. The method of claim 1 wherein the sand content ratio is in the range of 1 percent to 7 percent.

4. The method of claim 1 wherein the sand content ratio is zero percent.

5. The method of claim 1 wherein the pervious concrete panel has a void ratio in the range of 16 percent to 22 percent.

6. The method of claim 4 wherein the void ratio is in the range of 18 percent to 22 percent.

7. A method for producing a pervious concrete panel comprising:
providing a pervious concrete mix having a an aggregate size in the range of about one-eighth inch to about three-quarters inch and a and content ratio in the range of zero percent to 10 percent;
providing at least one lifting member;
forming the panel having a peripheral surface with a continuously moving form;
forming at least one aperture in the peripheral surface;
arranging the lifting member in the mix at a predetermined location in the peripheral surface prior to the mix fully curing.

8. The method of claim 7 wherein the form comprises a slip-forming machine.

9. The method of claim 7 wherein the form comprises an extruding machine.

10. The method of claim 7 wherein the aggregate size is in the range of about one-eight inch to about one-half inch.

11. The method of claim 7 wherein the sand content ratio is in the range of 1 percent to 7 percent.

12. The method of claim 7 wherein the sand content ratio is zero percent.

13. The method of claim 7 wherein the pervious concrete panel has a void ratio in the range of 16 percent to 22 percent.

14. The method of claim 13 wherein the void ratio is in the range of 18 percent to 22 percent.
